(19) United States
(12) Patent Application Publication
(10) Pub. No.: US 2015/0051936 A1
(43) Pub. Date: Feb. 19, 2015

(54) RESOURCE PLANNING SYSTEM AND METHOD FOR CLASSIFICATION PRODUCTS

(71) Applicant: NATIONAL TSING HUA UNIVERSITY, Hsinchu (TW)

(72) Inventors: Chen-Fu CHIEN, Hsinchu (TW); Jia-Nian ZHENG, Hsinchu (TW)

(73) Assignee: NATIONAL TSING HUA UNIVERSITY, Hsinchu (TW)

(21) Appl. No.: 14/087,300

(22) Filed: Nov. 22, 2013

(30) Foreign Application Priority Data
Aug. 16, 2013 (TW) 102129393

(51) Int. Cl. G06Q 10/06

(52) U.S. Cl. CPC G06Q 10/06313
USPC 705/7.23

(57) ABSTRACT

Disclosure is a resource planning system and method for classification products. The system comprises an input module and a planning module. The input module is used to receive wafer information, manufacturing process information, classification product information and order information. The wafer information comprises a wafer purchasing cost and a wafer inventory cost; the manufacturing process information comprises a production distribution and a production cost for the manufacturing process; the classification product information comprises a classification product inventory cost; the order information comprises a sale amount of customer orders and a penalty cost by unmet orders. The planning module calculates a profit by deducting the wafer purchasing cost, the production cost, the wafer inventory cost, the classification product inventory cost and the penalty cost from the sale amount. The profit gets the maximum value by planning resource allocation of each module.

### CROSS-REFERENCE TO RELATED APPLICATION

This application claims the benefit of Taiwan Patent Application No. 102129393, filed on Aug. 16, 2013, in the Taiwan Intellectual Property Office, the disclosure of which is incorporated herein its entirety by reference.

### BACKGROUND OF THE INVENTION

1. Field of the Invention

The present application generally relates to a resource planning system and method, especially with respect to the production of semiconductor wafer including a resource planning system and method for classification products.

2. Description of the Related Art

While manufacturing electronic product, in accordance with the characteristics of processes and materials, there are different grading or classification of customer needs, such as the LED products are classified by the luminous intensity, color wavelength, the reference voltage, or the solar cells are classified by generating efficiency, resistances, appearance and so on; however, the customers often only require specific classification products, as a result, the needs for different classification products, from material procurement, orders to the process of manufacturing etc. are all supposed to take into consideration; otherwise, once the finished products or the purchase of materials cannot meet the customers' demands and thus being eliminated, the existing inventory will cause tremendous loss to the factory.

At present, the enterprise resource planning is mainly based on the customers' orders in principle, planning for the allocation of resource among purchase, production, inventory, shipment and so on based on the amount of customers' demands; whereas, when the products are of classification characteristic, the needs for customer's orders often have special production limitation related to designed specification, manufacturing process and so on, and if satisfying with customers' demand based on the existing resource planning, in the meanwhile, it may need a large number of procurement or result in a great deal of inventory of work in process. In view of the speed of technology revolution towards the existing electronic product, those inventory may all become waste materials which being eliminated, and the cost to deal with the problem will greatly reduce the benefit of enterprise, consequently, how to design a resource planning system that fits into classification production characteristic will be an urgent demand for related manufacturing industry.

Hence, the present invention provides a resource planning system and method for classification products, which by means of conditions of material procurement, producing and manufacturing along with investing different resources among the order distribution for each of the classification products to get the maximum value of the profit.

### SUMMARY OF THE INVENTION

In view of the aforementioned problems, the aim of the present invention is to provide a resource planning system and method for classification products, to overcome the drawbacks of the prior art with respect to planning for classification products which incapable of enterprise getting optimum profit.

According to an aim of the present invention, a resource planning system for classification products comprises an input module and a planning module. The input module is used to receive wafer information, manufacturing process information, classification product information and order information, wherein, the wafer information comprises wafer purchasing cost and wafer inventory cost of wafer; manufacturing process information comprises a plurality of production process recipes process the wafer as classification products, including the output distribution and production cost thereof; the classification product information comprises the classification product inventory cost for classification products; the order information comprises the sale amount of customer order and the penalty cost by unmet orders. The planning module calculates a profit by deducting the wafer purchasing cost, the production cost, the wafer inventory cost, the classification product inventory cost and the penalty cost by unmet orders from the sale amount to get the maximum value of the profit as the goal and planning resource allocation having wafer purchasing amount, wafer inventory amount, wafer production amount, classification product production amount, classification product inventory amount, classification product demand amount and unmet order amount.

Preferably, in which the profit is calculated by following formula: P=S−C_{c}−Cₚ−I_{c}−Iₚ−Cₙ, wherein P: the profit; S: the sale amount, is the sum of all the classification product demand amount multiplies a classification product selling price; C_{c}: the wafer purchasing cost, is the sum of all the wafer purchasing amount multiplies a purchasing unit cost; Cₚ: the production cost; I_{c}: is the sum of all the wafer production amount multiplies a manufacturing process cost; the wafer inventory cost, is the sum of all the wafer inventory amount multiplies a wafer inventory handling cost; Iₚ: the classification product inventory cost, is the sum of the classification product inventory amount multiplies a product inventory handling cost; Cₙ: the penalty cost by unmet orders, is a penalty money caused by while the unmet order amount occurring.

Preferably, the planning module uses a linear programming way to calculate and plans the resource allocation.

Preferably, the planning module further comprises a wafer purchasing amount limit, which is the wafer supply provided by vendor, or is determined by a maximum purchasing amount and a minimum purchasing amount concluded by a purchase contract.

Preferably, the planning module further comprises a report module, wherein the report module can output a wafer report, a distribution report, a tracing report, an order report and a financial report.

According to an aim of the present invention, a resource planning method for classification products, applied to the resource planning system for classification products, the resource planning system for classification products comprises an output module and a planning module, wherein, of which comprises the following steps: receiving wafer information on a wafer having a wafer purchasing cost and a wafer inventory cost via the input module; receiving manufacturing process information on a plurality of production manufacturing process recipes having a production distribution and a production cost via the input module; receiving classification product information having a classification production inventory cost via the input module; receiving order information having a sale amount and a penalty cost by unmet orders via the input module; using the planning module to calculate a profit by deducting the wafer purchasing cost, the production cost, the wafer inventory cost, the classification production inventory cost and the penalty cost by unmet orders from the sale amount; planning a wafer purchasing amount, a wafer inventory amount, a wafer production amount, a classification product production amount, a classification product inventory amount, a classification product demand amount and an unmet order amount of a resource allocation to get the maximum value of the profit via the planning module.

Preferably, the resource planning method for classification products further comprises the following steps: planning module uses a linear programming way to calculate and plans the resource allocation.

Preferably, the resource planning method for classification products further comprises the following steps: receiving a wafer supply provided by vendor or a maximum purchasing amount and a minimum purchasing amount concluded by a purchase contract as a wafer purchasing amount limit via the planning module.

Preferably, the resource planning method for classification products further comprises the following steps: outputting a wafer report, a distribution report, a tracing report, an order report and a financial report by a report module.

As the aforementioned above, in accordance with the resource planning system and method for classification products, comprises one or more advantages as following:

(1) The resource planning system and method for classification products can satisfy with customer demands as well as get the maximum profit to enterprise by means of planning material purchasing, production amount, manufacturing process for production and so on.

(2) The resource planning system and method for classification products can promote the profit to enterprise in whole by means of effectively controlling material inventory so that reducing inventory handling cost.

(3) The resource planning system and method for classification products can provide the optimum resource distribution result to each department for reference and calculation by means of the optimum planning project obtained by a linear programming.

### BRIEF DESCRIPTION OF THE DRAWINGS

FIG. 1 is a block diagram of resource planning system for classification products of the present invention.

FIG. 2 is a schematic view of resource planning system for classification products in accordance with an embodiment of the present invention.

FIG. 3 is a flow diagram of resource planning system for classification products of the present invention.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

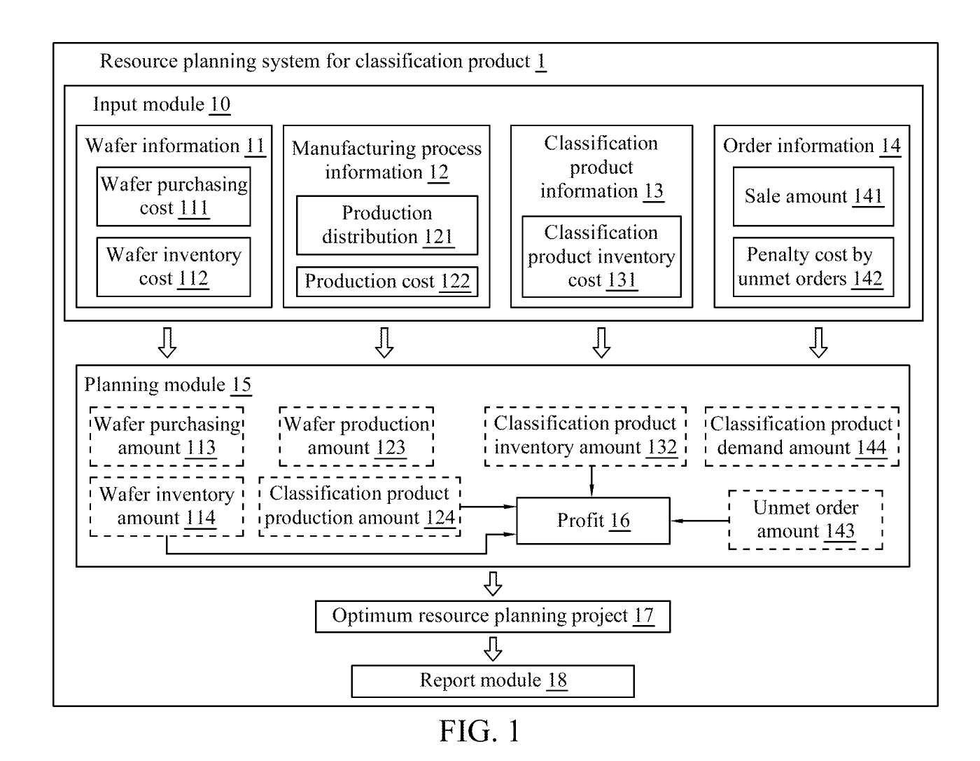

With reference to FIG. 1 for a block diagram of resource planning system for classification products of the present invention, the resource planning system for classification products 1 comprises an input module 10, and the input module 10 receiving wafer information 11, manufacturing process information 12, classification product information 13 and order information 14. The wafer information comprises information of wafer purchasing coast 111 and wafer inventory cost 112 of wafer; the manufacturing process information 12 comprises production distribution 121 and production cost 122 generated by manufacturing process recipes for processing the wafer to the classification products; the classification product information 13 comprises the information of classification product inventory cost 131; the order information 14 comprises sales amount 141 of customer orders and the information of a penalty cost by unmet orders 142. The planning module 15 calculates a profit 16 by deducting the wafer purchasing cost 111, the production cost 122, the wafer inventory cost 112, the classification product inventory cost 131 and the penalty cost by unmet orders 142 from the sale amount 141, wherein, the wafer purchasing cost 111 is the cost generated by all wafer purchasing amount 113, production cost 122 is the manufacturing cost spent by the classification product production amount 124 generated by all the wafer production amount 123, the wafer inventory cost 112 and classification product inventory cost 131 are respectively the costs spent by handling all the wafer inventory amount 114 and classification product inventory amount 132, the penalty cost by unmet orders 142 is the additional penalty cost while the unmet order amount 143 occurring, the whole sale amount 141 is the amount of selling all the classification product demand amount 144, the whole profit 16 is result by the sale amount 141 deduces the all production costs; due to the resource allocation among the wafer purchasing amount 113, wafer production amount 123, classification product production amount 124, wafer inventory amount 114, classification product inventory amount 132, unmet order amount 143 and classification product demand amount 144 is not the same, so that different profit 16 will be generated under the circumstance of investing different resource; and the planning module 15 uses a linear programming way to calculate the optimum resource planning project 17 to maximize the profit 16 as the goal, and the optimum resource planning module project 17 may further be presented by a report module 18, wherein the report module 18 may divide the optimum resource planning project 17 into the wafer report, distribution report, tracing report, order report and financial report and output to the corresponding department or examination and practice for user, respectively.

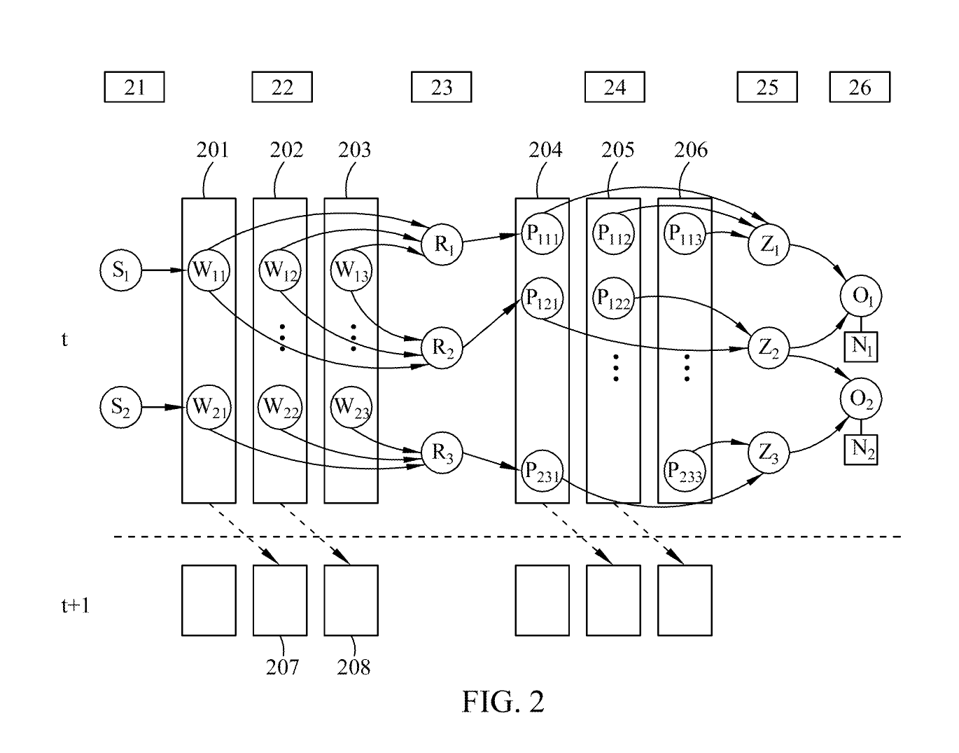

With reference to FIG. 2 for a schematic view of resource planning system for classification products in accordance with an embodiment of the present invention, As shown in the drawing, the area planned by the system comprises that the wafer stored in the wafer inventory 22 is purchasing from the wafer vendor 21 and puts the wafer into the manufacturing process 23 to produce classification products with different specification, catalogs into the classification product inventory 24 and finally distributes the classification products to satisfy the classification product demand 25 among the customer orders 26. The purchasing unit purchases two kinds of wafers, S₁ and S₂ from the vendor 21 in the period t and stores them in the wafer inventory 22, of which includes current wafer inventory 201, last month wafer inventory 202 and before last month wafer inventory 203, the two kinds of wafers, S₁ and S₂ cataloged into the current wafer inventory 201 as wafer inventory W₁₁ and W₂₁, wafer inventory W₁₁ has wafer inventory W₁₂ and W₁₃ which have the same wafer but exclude different inventory time, and the same wafer inventory W₂₁ has wafer inventory W₂₂ and W₂₃ which have the same wafer but exclude different inventory time. The above wafer inventory can be processed in the manufacturing process R₁, R₂ and R₃ according to different specification to be formed as different classification product inventory P₁₁₁, P₁₂₁ and P₁₃₁, cataloging into the current classification product inventory 204 of the classification product inventory 24, and the classification product inventory 24 also includes the last month classification product inventory 205 and before last month classification product inventory 206, storing the classification products produced in last month and before the last month, respectively.

The above classification product inventory 24 is to satisfy with the different classification product demand 25 among the customer orders 26. As can be shown in figure, the current customer order O₁ includes two kinds of different classification product demands Z₁ and Z₂, and the customer order O₂ also includes two kinds of different classification product demands Z₃ and Z₄, the specification of classification product demand Z₁ is manufactured by wafer S₁ through manufacturing process R₁, consequently, the classification product demand Z₁ can be satisfied by different periods of classification product inventory P₁₁₁, P₁₂₁ and P₁₃₁; similarly, the classification product demand Z₂ and Z₃ can be satisfied by the classification product inventory P₁₂₁, P₁₂₂, P₂₃₁ and P₂₃₃ with designed specification; besides, as the classification product inventory 24 is not bound to satisfy with the classification product demand 25, so that if it can be satisfied, unmet order amount N₁ and N₂ may be respectively produced in the customer orders O₁ and O₂. In addition, the original wafer in the wafer inventory 22, while in t+1 period, the current wafer inventory 201 turns into the latest last month wafer inventory 207 and the last month wafer inventory 202 turns into the latest before last month wafer inventory 208 and the classification product inventory 24 can be inferred as the same to distinguish the different inventory time between wafer and classification products, so that can easy to calculate the different handling costs, and whether the wafer or the classification products that in inventory is over three periods, are all possible to become eliminated inactive inventory.

According to the aforementioned planned scope and content, building the planning module for resource planning system for classification products, wherein, the goal of planning is to maximize the profit in whole, so the calculation of profit is regarded as the main body, adding kinds of conditions for limitation, and further pursuing the maximum of profit by a linear programming way, and the invested amount of different resources obtained while the profit is of maximum will be served as the optimum planning project. The calculation of profit can be shown in following formula: Max P=S−C_{c}−Cₚ−I_{c}−Iₚ−Cₙ, wherein P: the profit; S: the sale amount; C_{c}: the wafer purchasing cost; Cₚ: a production cost; I_{c}: a wafer inventory cost; Iₚ: a classification product inventory cost; Cₙ: a penalty cost by unmet orders The further detail thereof is as following:

$$P = {\sum }_{w} {\sum }_{b} {\sum }_{o} {\sum }_{t} {\sum }_{a} {z}_{w , b , o , t , a} \times {price}_{o , b , t} - {\sum }_{w} {\sum }_{t} {x}_{w , t} \times {C}_{w , t}^{c} - {\sum }_{r} {\sum }_{t} {\sum }_{a} {y}_{r , t , a} \times {C}_{r}^{p} - {\sum }_{w} {\sum }_{t} {\sum }_{a} {i}_{w , t , a}^{c} \times {C}_{w , a}^{chip} - {\sum }_{w} {\sum }_{b} {\sum }_{t} {\sum }_{a} {i}_{w , b , t , a}^{p} \times {C}_{b , a}^{product} - {\sum }_{o} {\sum }_{t} {nsd}_{o , t} \times {C}_{o , t}^{nsd}$$

Setting the amount of how many kinds of wafers w, producing classification product b through manufacturing processes r to satisfy with the demand for orders o, in which the purchasing period is t, ages of inventory is a, and the parameter being planned is:
z_{w,b,o,t,a}: classification product b through manufacturing processes r, inventory age a, demand for order o supplied in period t;
x_{w,t}: purchasing amount of wafer w in period t
y_{r,t,a}: wafer production amount through manufacturing processes r and inventory age a in period t
i_{w,t,a}^{c}: wafer inventory amount of wafer w in inventory age a, period t
i_{w,b,t,a}^{p}: product inventory amount through manufacturing processes r, classification product b in inventory age a, period t
nsd_{o,t}: unmet order amount of orders o in period t
The above parameter desired to plan has to cooperate with the known parameter so that the value of whole profit can be calculated, wherein, price_{o,b,t} is the price of classification product b of orders o in period t; C_{w,t}^{c} is the purchasing cost of wafer w in period t; Cᵣ^{p} is the production cost of manufacturing processes r; C_{w,a}^{chip}: is the inventory handling coast of wafer w of inventory age a; C_{b,a}^{product}: is the inventory handling cost of classification product b of inventory age a; C_{o,t}^{nsd}: is the penalty cost by unmet orders of orders o in period t. In addition, according to the above calculation, setting the relevant conditions for limitation, avoiding result of planning unmatched real circumstance, the main restraint thereof includes wafer purchasing amount limit, wafer amount balance limit, production balance limit, classification product amount balance limit and customer demand balance limit. The wafer purchasing amount limit is mainly because that wafer purchasing may be contracted with vendors, involving in the maximum or minimum purchasing amount and the supply will be different based on supplier, so the purchasing amount limit has to be set; the wafer amount balance limit is to explain that wafer may be used for producing directly or entering wafer inventory after purchasing, consequently, the investment of wafer production amount includes the current purchasing amount and different inventory age wafer inventory amount, and when inventory age is over three months, the wafer specification may be the kind that close to being eliminated, so it takes a higher handling cost while handling wafer inventory. The same classification product balance limit is similar to the wafer amount balance limit, has to take classification product inventory into account in order to satisfy customer demand, and classification products that is over three months may cannot be sold and with a higher inventory handling cost; the production balance limit is after wafer production, according to different manufacturing process or the classification product characteristic while producing, different production yield rate is thus caused, and it also needs to concern about yield rate to avoid from producing too many defective products so that fails to satisfy with the order demand when planning. Finally, the customer demand balance limit is to set if the customer orders have the least satisfied amount or replaced specification amount limit, and while all the order demand cannot be satisfied, in case of having the least satisfied amount or can be replaced by other specification product, can avoid from generating penalty cost, resulting in quite difference in planning.

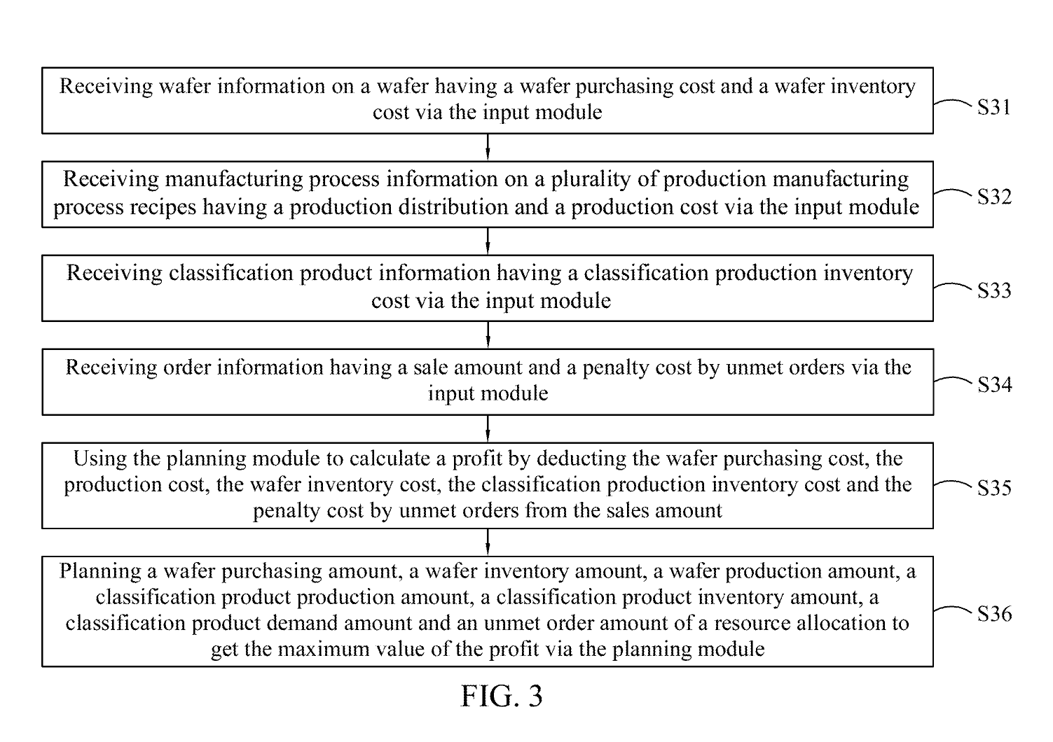

With reference to FIG. 3 for a flow diagram of resource planning system for classification products of the present invention. The resource planning method for classification products can be applied to the aforementioned resource planning system for classification products, wherein, the step of method may be:

Step 31: receiving wafer information on a wafer having a wafer purchasing cost and a wafer inventory cost via the input module.

Step 32: receiving manufacturing process information on a plurality of production manufacturing process recipes having a production distribution and a production cost via the input module.

Step 33: receiving classification product information having a classification production inventory cost via the input module.

Step 34: receiving order information having a sale amount and a penalty cost by unmet orders via the input module.

Step 35: using the planning module to calculate a profit by deducting the wafer purchasing cost, the production cost, the wafer inventory cost, the classification production inventory cost and the penalty cost by unmet orders from the sale amount.

Step 36: planning a wafer purchasing amount, a wafer inventory amount, a wafer production amount, a classification product production amount, a classification product inventory amount, a classification product demand amount and an unmet order amount of a resource allocation to get the maximum value of the profit via the planning module.

The above steps are that after the wafer information, manufacturing process information, classification product information and order information in the input module are confirmed, according to the investment resource of different wafer purchasing amount, wafer inventory amount, wafer production amount, classification product production amount, classification product inventory amount, classification product demand amount and unmet order amount to calculate the optimum resource allocation for maximizing the profit by a linear programming way. The above optimum resource allocation includes information of each department which comprises procurement department, production and management department, manufacturing department, sales department and finance department. In the past, whenever planning the investment resource amount for each department, the point is mainly focused on goals of each department and needs to over and over again to change production plan so that can reach to customer demand, but the planning resource system and method for classification products aims at maximizing the profit of enterprise, planning the investment resource each department needs and outputting the information that the above departments need on report, such as wafer report, distribution report, tracing report, order report and financial report and so on to provide to the staff of the departments for reviewing and application.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A resource planning system for classification products, comprising:
an input module receiving wafer information, manufacturing process information, classification product information and order information, wherein, the wafer information includes a wafer having a wafer purchasing cost and a wafer inventory cost, the manufacturing process information comprises a plurality of production process recipes, a production distribution and a production cost, the plurality of production process recipes process the wafer as a classification product, the classification product information comprises a classification product inventory cost of the classification products, the order information comprises a sale amount of customer orders and a penalty cost by unmet orders; and
a planning module calculates a profit by deducting the wafer purchasing cost, the production cost, the wafer inventory cost, the classification product inventory cost and the penalty cost by unmet orders from the sale amount to get the maximum value of the profit as goal, planning a resource allocation having a wafer purchasing amount, a wafer inventory amount, a wafer production amount, a classification product production amount, a classification product inventory amount, a classification product demand amount and an unmet order amount.

2. The resource planning system for classification products according to claim 1, wherein, the profit is calculated in accordance with the following formula: P=S−C_{c}−Cₚ−I_{c}−Iₚ−Cₙ, wherein P: the profit; S: the sale amount, is the sum of all the classification product demand amount multiplies a classification product selling price; C_{c}: the wafer purchasing cost, is the sum of all the wafer purchasing amount multiplies a purchasing unit cost; Cₚ: the production cost, is the sum of all the wafer production amount multiplies a manufacturing process cost; I_{c}: the wafer inventory cost, is the sum of all the wafer inventory amount multiplies a wafer inventory handling cost; Iₚ: the classification product inventory cost, is the sum of the classification product inventory amount multiplies a product inventory handling cost; Cₙ: the penalty cost by unmet orders, is a penalty money caused by while the unmet order amount occurring.

3. The resource planning system for classification products according to claim 1, wherein the planning module is calculated by a linear programming way and plans the resource allocation.

4. The resource planning system for classification products according to claim 1, wherein the planning module further comprises a wafer purchasing amount limit, which is a wafer supply provided by a vendor, or is determined by a maximum purchasing amount and a minimum purchasing amount concluded by a purchase contract.

5. The resource planning system for classification products according to claim 1, further comprising a report module, wherein the report module outputting a wafer report, a distribution report, a tracing report, an order report and a financial report.

6. A resource planning method for classification products is applied to a resource planning system for classification products, which comprises an input module and a planning module, wherein, the resource planning method for classification product comprises following steps:
receiving wafer information on a wafer having a wafer purchasing cost and a wafer inventory cost via the input module;
receiving manufacturing process information on a plurality of production process recipes having a production distribution and a production cost via the input module;
receiving classification product information having a classification production inventory cost via the input module;
receiving order information having a sale amount and a penalty cost by unmet orders via the input module;
using the planning module to calculate a profit by deducting the wafer purchasing cost, the production cost, the wafer inventory cost, the classification production inventory cost and the penalty cost by unmet orders from the sale amount; and
planning a wafer purchasing amount, a wafer inventory amount, a wafer production amount, a classification product production amount, a classification product inventory amount, a classification product demand amount and an unmet order amount of a resource allocation to get the maximum value of the profit via the planning module.

7. The resource planning method for classification products according to claim 6, further comprising following calculation steps:
the planning module uses a linear programming way to calculate and plans the resource allocation.

8. The resource planning method for classification products according to claim 6, further comprising following calculation steps:
receiving a wafer supply provided by a vendor or a maximum purchasing amount and a minimum purchasing amount concluded by a purchase contract as a wafer purchasing amount limit via the planning module.

9. The resource planning method for classification products according to claim 6, further comprising following calculation steps:
outputting a wafer report, a distribution report, a tracing report, an order report and a financial report by a report module.
